(19) United States
(12) Patent Application Publication
(10) Pub. No.: US 2012/0293524 A1
(43) Pub. Date: Nov. 22, 2012

(54) DISPLAY DEVICE

(75) Inventor: Kenshi Tada, Osaka (JP)

(73) Assignee: SHARP KABUSHIKI KAISHA, Osaka (JP)

(21) Appl. No.: 13/521,261

(22) PCT Filed: Oct. 29, 2010
(86) PCT No.: PCT/JP2010/069356

§ 371 Date: Jul. 10, 2012

(30) Foreign Application Priority Data
Jan. 13, 2010 (JP) 2010-005252

(51) Int. Cl. G06T 1/60

(52) U.S. Cl. 345/530

(57) ABSTRACT

A display device (100a) is provided with a display unit (160), an antenna unit (110) that receives electromagnetic waves from a reader/writer device (200), a communication data processing unit (131a) that acquires communication data transmitted by the electromagnetic waves, a display data processing unit (132a) that generates, from the communication data, the display data to be displayed on the display unit (160) and that stores the display data in a display data storage unit (143), a display control unit (150) that outputs the display data to the display unit (160), a power generation unit (170) that is activated when receiving the electromagnetic waves and that supplies power acquired from the electromagnetic waves at least to the communication data processing unit (131a), the display data processing unit (132a), the display unit (160), the display control unit (150), and to the display data storage unit (143), and a display power source unit (180) that is activated when not receiving the electromagnetic waves and that supplies power to the display unit (160), the display control unit (150), and the display data storage unit (143).

### TECHNICAL FIELD

The present invention relates to a display device that is supplied with power from an external device and that displays data acquired from the external device on a display unit.

### BACKGROUND ART

In recent years, contact type and non-contact type IC (Integrated Circuit) cards have been widely used as devices to make a payment or verify identification information. The non-contact type IC cards (hereinafter referred to as non-contact IC cards) are capable of wireless communication with a reader/writer device, which is an external device, through electromagnetic waves in particular, and therefore, if non-contact IC cards are applied to commuter passes, for example, just by holding the commuter pass over a dedicated reader/writer device that is set up at a ticket gate at a train station, train fare adjustment or the like according to a balance or usage status information stored in the commuter pass can be performed instantly.

In order to acquire information stored in the non-contact IC cards through the reader/writer device, users are required to hold the non-contact IC cards over the reader/writer device. Thus, the users could encounter a situation where they learn that they cannot use their non-contact IC cards because of insufficient balance or the like only after they tried to use their non-contact IC cards. Therefore, in recent years, a non-contact IC card provided with a display unit to display information that is stored in the non-contact IC card has been proposed.

Patent Documents 1 and 2 disclose techniques regarding the non-contact IC card provided with a display unit.

Patent Document 1 discloses a mobile wireless device provided with a display device to display stored contents, a display driver circuit that performs display, and a power source for driving the display driver circuit.

Patent Document 2 discloses an IC card provided with a CPU (Central Processing Unit; hereinafter referred to as a communication CPU) that is used for sending and receiving data between an IC card and a reader/writer device, a memory that stores data to be displayed on a display unit, a low-power-consumption CPU (hereinafter referred to as a display CPU) that displays the data, and a communication unit for connecting these two CPUs to each other.

### RELATED ART DOCUMENTS

### Patent Documents

Patent Document 1: Japanese Patent Application Laid-Open Publication No. 2002-99886 (Publication Date: Apr. 5, 2002)

Patent Document 2: Japanese Patent Application Laid-Open Publication No. 2007-188413 (Publication Date: Jul. 26, 2007)

### SUMMARY OF THE INVENTION

### Problems to be Solved by the Invention

As shown in FIG. 1 of Patent Document 1, when a mobile wireless device disclosed in Patent Document 1 displays image data on a display device, the mobile wireless device drives a control circuit (control circuit 8 in FIG. 1) that controls all of integrated circuits that constitute the mobile wireless device, and the mobile wireless device displays, on the display device, the image data that is generated based on the data stored in the memory. As described, because the mobile wireless device disclosed in Patent Document 1 consumes much power to drive the control circuit that controls the entire integrated circuits, if a battery with a small charging capacity is used as the power source, it is difficult to use the mobile wireless device for a long period of time, and it is difficult to operate the mobile wireless device with a solar battery having small output power.

In the IC card disclosed in Patent Documents 2, as shown in FIG. 1 of Patent Document 2, when updated data is to be displayed on a display unit, a display CPU (CPU 203 in FIG. 1) accesses a communication CPU (CPU 302 in FIG. 1), and data stored in memory is transferred to a data display unit by communication units (I/O 206 and 301 in FIG. 1). As described, the IC card disclosed in Patent Document 2 has a complex configuration in which the display of the updated data is controlled by using two CPUs as the control units. Also, in displaying the updated data, it is necessary to access the communication CPU that consumes much power, and therefore, the IC card requires a large amount of power. Thus, when the IC card is applied to a commuter pass that is used for train fare adjustment and the like, because data such as usage status information is frequently updated, it poses a problem of increasing the power consumption.

The present invention was made in view of the above-mentioned problems, and its object is to provide a display device that suppresses consumption of power for data display in the device when no power is supplied from an external device.

### Means for Solving the Problems

In order to solve the above-mentioned problems, a display device according to the present invention includes a display unit, an antenna unit that receives electromagnetic wave from an external device, a communication data acquisition unit that acquires communication data carried by the electromagnetic wave, a display data generation unit that generates, from the acquired communication data, display data to be displayed on the display unit and that stores the generated display data in a display data storage unit, a display control unit that outputs the display data stored in the display data storage unit to the display unit, a first power supply unit that is activated when the antenna unit is receiving the electromagnetic wave, the first power supply unit supplying power acquired from the received electromagnetic wave to at least the communication data acquisition unit, the display data generation unit, the display unit, the display control unit, and to the display data storage unit, and a second power supply unit that is activated when the antenna unit is not receiving the electromagnetic wave, the second power supply unit supplying power to the display unit, the display control unit, and to the display data storage unit.

According to this configuration, when the electromagnetic waves are received, the power is supplied to at least the communication data acquisition unit, the display data generation unit, and the display data storage unit. Therefore, when the electromagnetic waves are received, first, the communication data is acquired, and the display data is generated and the generated display data is stored in the display data storage unit. Further, according to the above-mentioned configuration, when the electromagnetic waves are received, the power is also supplied to the display unit and the display control unit. Therefore, it is also possible to output the display data stored in the display data storage unit to the display unit.

On the other hand, when the electromagnetic waves are not received, the power is supplied to the display unit, the display control unit, and the display data storage unit, and the display data stored in the display data storage unit can be output to the display unit. If the display data has already been output to the display unit, the output of the display data to the display unit is maintained.

Therefore, when the electromagnetic waves are received, with the power acquired from the electromagnetic waves, the display device can drive the communication data acquisition unit and the display data generation unit and complete at least generation of the display data, and when the electromagnetic waves are not received, the display device can output the display data to the display unit without driving the communication data acquisition unit and the display data generation unit.

When the display device completes the process of driving the display unit and the display control unit and outputting the generated display data to the display unit during a period in which the electromagnetic waves are received, the display device maintains the output of the display data to the display unit without driving the communication data acquisition unit and the display data generation unit when the electromagnetic waves are not received.

Because the communication data acquisition unit and the display data generation unit are typically operated by a control unit such as a CPU that consumes much power, by not driving these units when the electromagnetic waves are not received, the display data can be output to the display unit with low power consumption.

This makes it possible to reduce the power consumption of the second power supply unit, which results in an effect of saving energy.

The second power supply unit needs to supply power to the display unit, the display control unit, and the display data storage unit only. Therefore, a battery with small charging capacity, a solar battery with small output power, or the like can be employed, which results in effects of reducing the size of hardware in the device and lowering the manufacturing cost.

### Effects of the Invention

As described above, a display device according to the present invention is provided with a display unit, an antenna unit that receives electromagnetic wave from an external device, a communication data acquisition unit that acquires communication data carried by the electromagnetic waves, a display data generation unit that generates, from the acquired communication data, display data to be displayed on the display unit and that stores the generated display data in a display data storage unit, a display control unit that outputs the display data stored in the display data storage unit to the display unit, a first power supply unit that is activated when the antenna unit is receiving the electromagnetic wave and that supplies power acquired from the received electromagnetic wave to at least the communication data acquisition unit, the display data generation unit, the display unit, the display control unit, and to the display data storage unit, and a second power supply unit that is activated when the antenna unit is not receiving the electromagnetic wave and that supplies power to the display unit, the display control unit, and to the display data storage unit.

With this configuration, when the electromagnetic waves are received, the display device can drive the communication data acquisition unit and the display data generation unit and completes at least generation of the display data with the power acquired from the electromagnetic waves, and therefore, when the electromagnetic waves are not received, the display device can output the display data to the display unit without driving the communication data acquisition unit and the display data generation unit.

When the display device completes the process of driving the display unit and the display control unit and outputting the generated display data to the display unit during a period in which the electromagnetic waves are received, the display device can maintain the output of display data to the display unit without driving the communication data acquisition unit and the display data generation unit when the electromagnetic waves are not received.

Because the communication data acquisition unit and the display data generation unit are typically operated by a control unit such as a CPU that consumes much power, by not driving these units when the electromagnetic waves are not received, the display device can output the display data to the display unit with low power consumption.

This makes it possible to reduce the power consumption of the second power supply unit, which results in an effect of saving power.

Further, because the second power supply unit needs to supply power to the display unit, the display control unit, and to the display data storage unit only, a battery with small charging capacity, a solar battery with small output power, or the like can be employed. As a result, effects of reducing the size of the hardware in the device and lowering the manufacturing cost can be achieved.

Additional objects, features, and effects of the present invention shall be readily understood from the descriptions that follow. Advantages of the present invention shall become apparent by the following descriptions with reference to the appended figures.

### BRIEF DESCRIPTION OF THE DRAWINGS

FIG. 1 is a block diagram showing a configuration of a display device according to an embodiment of the present invention.

FIG. 2 is a flowchart showing an example of a process flow in the display device shown in FIG. 1.

FIG. 3 is a block diagram showing a configuration of the display device according to another embodiment of the present invention.

### DETAILED DESCRIPTION OF EMBODIMENTS

A display device 100 according to each embodiment is a device that is capable of receiving electromagnetic waves from an external device and that acquires and displays information transmitted by the electromagnetic waves on a display unit. The display device 100 is a non-contact type IC card with a display unit. The external device is a so-called reader/writer device.

When it is not necessary to make a distinction between a display device 100a and a display device 100b, which will be described later, they are simply referred to as a “display device 100.”

### Embodiment 1

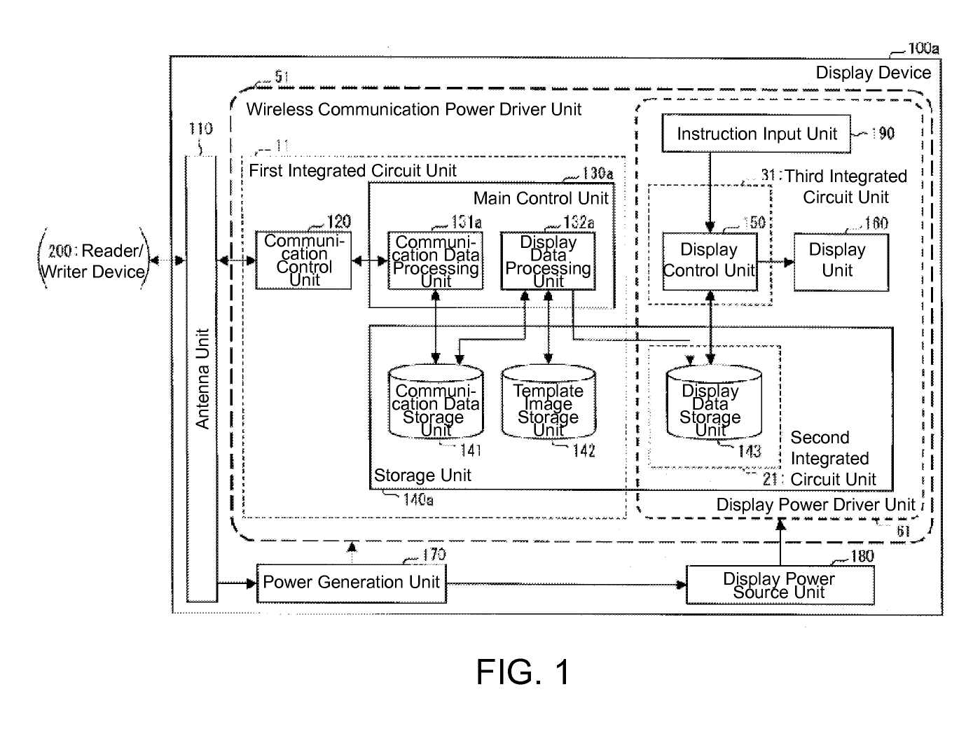

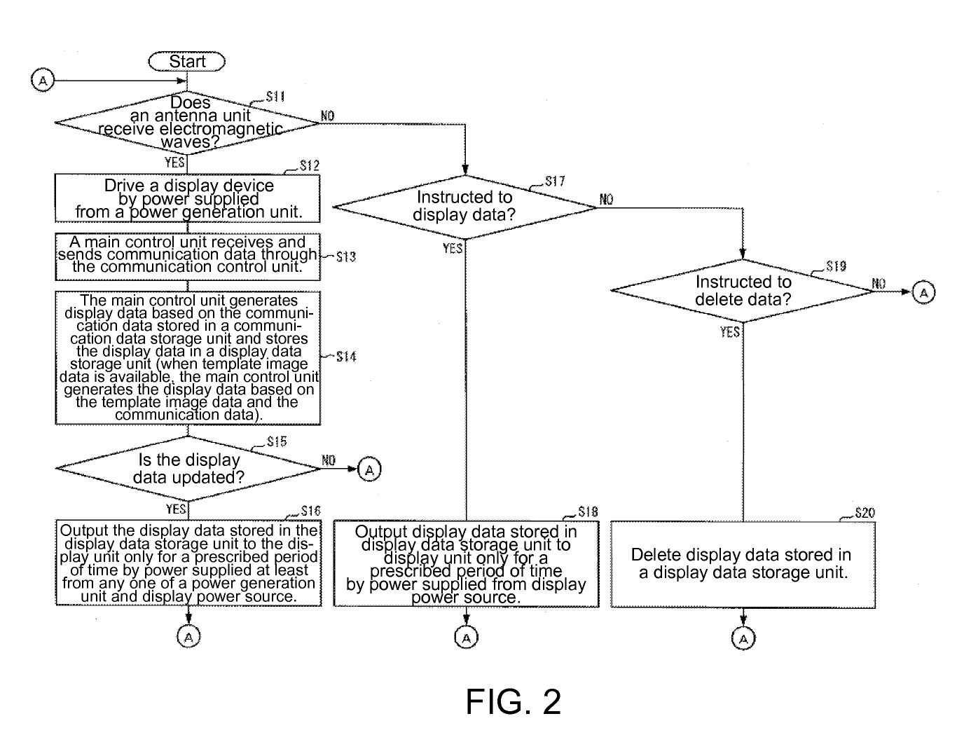

An embodiment of the present invention will be described below with reference to FIGS. 1 and 2.

Configuration of Display Device

A configuration of the display device 100a according to the present embodiment will be described with reference to FIG. 1. FIG. 1 is a block diagram showing a configuration of a primary portion of the display device 100a. As shown in FIG. 1, the display device 100a is provided with an antenna unit 110, a communication control unit 120, a main control unit 130a, a storage unit 140a, a display control unit 150, a display unit 160, a power generation unit (first power supply unit) 170, a display power source unit (second power supply unit) 180, and an instruction input unit 190.

The antenna unit 110 is a known antenna unit that receives electromagnetic waves from a reader/writer device 200, which is an external device. The display unit 100a performs wireless communication by conveying signals carried by the electromagnetic waves received by the antenna unit 110, and sends or receives signals to or from the reader/writer device 200. The display device 100a is supplied with power from the electromagnetic waves received by the antenna unit 110.

The antenna unit 110 is constituted of a coil that performs wireless communication and a capacitor that tunes the signals. A capacitance of the capacitor is adjusted in advance such that the signals from the reader/writer device 200 are tuned.

The communication control unit 120 sends and receives the signals by controlling the antenna unit 110, and performs modulation, demodulation, and the like of the sent and received signals.

The storage unit 140a stores various kinds of data and the like that are read out by the main control unit 130a, and is constituted of a nonvolatile storage device such as EEPROM (electrically erasable programmable read-only memory). Specifically, the storage unit 140a includes a communication data storage unit 141 and a display data storage unit 143. Further, the storage unit 140a may include a template image storage unit (image data storage unit) 142.

The communication data storage unit 141 stores, in a readable state, a piece or a plurality of pieces of communication data acquired from the reader/writer device 200 by wireless communication. Here, the communication data is data that includes at least numerical data or text data that represents charging information, balance information, identification information, and the like. The communication data not only is used to generate display data, which will be described later, but also is read out by other programs or the like.

The communication data may include image data such as bitmap files for generating part or all of the display data, which will be described later.

The display data storage unit 143 stores, in a readable state, a piece or a plurality of pieces of display data to be displayed on the display unit 160. The display data is generated by a display data processing unit 132a, which will be described later, based on the communication data stored in the communication data storage unit 141. Specifically, the display data is image data such as bitmap files that represents contents of the communication data.

The template image storage unit 142 stores image data (hereinafter referred to as a template image data) that becomes a template of the display data.

The main control unit 130a controls operations of the respective units provided in the display device 100a. The main control unit 130a can be constituted of a CPU, memory, and the like, for example. In this case, the main control unit 130a reads out various programs stored in the storage unit 140a to a first storage unit that is constituted of RAM (Random Access Memory) or the like, for example, and runs the programs therein. This way, the main control unit 130a controls the respective units in the display device 100a, and various functions provided in the display device 100a are achieved.

The main control unit 130a may be constituted of hardware logic such as an ASIC (application specific integrated circuit).

The main control unit 130a is specifically provided with a communication data processing unit (communication data acquisition unit) 131a and the display data processing unit (display data generation unit) 132a.

The communication data processing unit 131a controls the communication control unit 120, acquires the communication data through the electromagnetic waves received by the antenna unit 110, and stores the acquired communication data in the communication data storage unit 141. Also, the communication data processing unit 131a reads out the communication data stored in the communication data storage unit 141, and sends the read-out communication data to the reader/writer device 200 through the communication control unit 120 and the antenna unit 110.

When the communication data is stored in the communication data storage unit 141, the display data processing unit 132a generates image data that shows contents of the stored communication data in a prescribed area, thereby generating display data. Thereafter, the display data processing unit 132a stores the generated display data in the display data storage unit 143.

If the template image data is stored in the template image storage unit 142, the display data processing unit 132a generates image data that represents contents of the communication data read out from the communication data storage unit 141, and the display data processing unit 132a generates the display data by combining the generated image data and the template image data that was read out from the template image storage unit 142.

The display control unit 150 reads out the display data stored in the display data storage unit 143, and sequentially outputs the read-out display data as signals for respective pixels that constitute the display unit 160 to the display unit 160 for a prescribed period of time. There is no special limitation on the prescribed period of time, and the duration thereof is from a few seconds to a few minutes, for example. The prescribed period of time may be set at the time of product shipment or may be set by a user.

The display control unit 150 includes an image signal circuit that outputs signals for the respective pixels and a display driver circuit that drives the display unit 160, and the signals to be input to scan signal lines and data signal lines that constitute the display unit 160 are controlled by these circuits.

The timing for outputting the display data stored in the display data storage unit 143 to the display unit 160 is at least: (1) when the instruction input unit 190 receives an instruction to output the display data stored in the display data storage unit 143 to the display unit 160; and (2) when the display data stored in the display data storage unit 143 is updated. However, the timing is not limited to such.

When the instruction input unit 190 receives an instruction to delete the display data stored in the display data storage unit 143, the display control unit 150 deletes the display data stored in the display data storage unit 143.

The display unit 160 is a known display device, and is provided with a liquid crystal panel, an organic EL (Electro Luminescence) panel, an electrophoresis panel, or the like, for example.

A panel of the display unit 160 may be made of low temperature polysilicon TFT (Thin Film Transistor) liquid crystal. This makes it possible to achieve a configuration in which the display unit 160 and the display control unit 150 are integrally formed (in other words, a configuration in which the display control unit 150 is built in the display unit 160, instead of a configuration in which the display unit 160 and the display control unit 150 are separately provided), which is typically known as a so-called SOG (System on Grass). This allows for a reduction in the number of components.

It is preferable that the display unit 160 be a so-called liquid crystal display device with built-in pixel memory (in other words, a display device that can continuously display images by maintaining output voltage of a digital memory element (storage element; SRAM) provided in each pixel even when the supply of the signals to the data signal lines and to the scan signal lines is discontinued). In such a liquid crystal display device with built-in pixel memory, while the signal that is input to the digital memory element remains the same, the output voltage of the digital memory element maintains the same status, and a pixel signal stored in the digital memory element is written in a liquid crystal cell (liquid crystal capacitance). Therefore, in the liquid crystal display device with built-in pixel memory, when the data is continuously displayed as a static image, the digital memory element and the like do not need to be switched, thereby reducing the power consumption. Therefore, when the display unit 160 is a liquid crystal display device with built-in pixel memory, it becomes possible to continuously display an image on the display unit 160 with low power consumption.

The power generation unit 170 includes a rectifying circuit that generates power from the electromagnetic waves received by the antenna unit 110. When the antenna unit 110 is receiving the electromagnetic waves (in other words, when the antenna unit 110 is communicating wirelessly with the reader/writer device 200), the power generation unit 170 supplies power (also referred to as wireless communication power below) generated by the rectifying circuit to each of the units provided in the display device 100a. Specifically, the power generation unit 170 supplies the wireless communication power respectively to the communication control unit 120, the main control unit 130a, the storage unit 140a, the display control unit 150, the display unit 160, and the instruction input unit 190. Here, the above-mentioned respective units that receive the wireless communication power from the power generation unit 170 are referred to as a wireless communication power driver unit 51 in FIG. 1.

As described later, the display data storage unit 143, the display control unit 150, the display unit 160, and the instruction input unit 190 are supplied with power by the display power source unit 180, and therefore, the power generation unit 170 may not need to supply power to these units.

The display power source unit 180 supplies power to the respective units that are used to display the display data on the display unit 160 when the antenna unit 110 is not receiving the electromagnetic waves (in other words, when the antenna unit 110 is not communicating wirelessly with the reader/writer device 200). Specifically, the display power source unit 180 supplies power respectively to the display data storage unit 143, the display control unit 150, the display unit 160, and the instruction input unit 190. These units that receive the power from the display power source unit 180 are referred to as a display power driver unit 61 in FIG. 1. However, when the instruction input unit 190 is not an electronic switch, the display power source unit 180 does not need to supply the power to the instruction input unit 190.

It is preferable that the display power source unit 180 supply power to the display power driver unit 61 only for a prescribed period of time after the instruction input unit 190 receives an instruction from the user, instead of continuously supplying power to the display power driver unit 61. This way, the power consumption can be reduced.

The display power source unit 180 may be a primary battery, a rechargeable battery, a solar battery, a capacitor, or a combination of such. Because the display device 100a is the non-contact type IC cards in particular, it is preferable that the display power source unit 180 employ a small power source such as a solar battery or a thin battery.

If the display power source unit 180 is a rechargeable battery, it is preferable that the display power source unit 180 be charged by power supplied from the power generation unit 170. This way, the display power source unit 180 is charged every time when the antenna unit 110 receives the electromagnetic waves.

The instruction input unit 190 is a group of switches that receive instructions from the user and control the display control unit 150 according to the received instructions. Possible instructions from the user at least include: (1) an instruction to output the display data stored in the display data storage unit 143 to the display unit 160; (2) an instruction to select the display data to be output to the display unit 160 when a plurality of pieces of display data are stored in the display data storage unit 143; and (3) an instruction to delete the display data stored in the display data storage unit 143.

When the display power source unit 180 is a solar battery, it is possible to configure the display device such that depending on whether the display power source unit 180 receives ambient light or not, the operation of the display control unit 150 and the output of the display data stored in the display data storage unit 143 to the display unit 160 are controlled. Therefore, in this configuration, the instruction input unit 190 is not necessarily required.

It is also possible to configure the display device such that, when the plurality of pieces of display data are stored in the display data storage unit 143, the plurality of pieces of display data are sequentially output to the display unit 160 without receiving the instructions from the user. Therefore, in this configuration, the instruction input unit 190 is not necessarily required. When the display power source unit 180 is a solar battery, it is possible to configure the display device such that the plurality of pieces of display data are sequentially output to the display unit 160 every time when the display power source unit 180 receives ambient light.

Example of Configuration of Integrated Circuits

When the respective units in the display device 100a are provided as integrated circuits, the following integrated circuits can be configured, for example: (1) one integrated circuit (first integrated circuit unit 11) constituted of the communication control unit 120, the main control unit 130a, the communication data storage unit 141, and the template image storage unit 142; (2) another integrated circuit (second integrated circuit unit 21) constituted of the display data storage unit 143; and (3) yet another integrated circuit (third integrated circuit unit 31) constituted of the display control unit 150. In this configuration, the display device 100a is constituted of the first integrated circuit unit 11, the second integrated circuit unit 21, and the third integrated circuit unit 31, in addition to the antenna unit 110. The first integrated circuit unit 11, the second integrated circuit unit 21, and the third integrated circuit unit 31 are driven by the wireless communication power supplied from the power generation unit 170. Also, the second integrated circuit unit 21 and the third integrated circuit unit 31 are driven by power supplied from the display power source unit 180. The first integrated circuit unit 11 is not driven by the power supplied from the display power source unit 180.

It is preferable that at least the first integrated circuit unit 11 be formed as a different IC chip from an IC chip(s) for the second integrated circuit unit 21 and the third integrated circuit unit 31. When the display unit 160 is made of low temperature polysilicon TFT (Thin Film Transistor) liquid crystal, it is preferable that the display unit 160 and the display control unit 150 be integrally formed. Because the first integrated circuit unit 11 is also included in the conventional IC card, it becomes possible to use a general-purpose IC chip for the IC chip for the first integrated circuit unit 11, and as a result, the manufacturing cost of the display device 100a can be reduced.

Even when the first integrated circuit unit 11, the second integrated circuit unit 21, and the third integrated circuit unit 31 are formed on a single IC chip, the above-mentioned two types of power sources (the power generation unit 170 and the display power source unit 180) are provided for the IC chip.

Characteristic Operations of Display Device

In the display device 100a having the above-mentioned configuration, when the antenna unit 110 receives the electromagnetic waves, the wireless communication power driver unit 51 is activated by the wireless communication power, and the main control unit 130a stores the communication data in the communication data storage unit 141 and also stores the display data in the display data storage unit 143. In other words, data storage and readout between the communication data storage unit 141 and the display data storage unit 143 are performed by the single main control unit 130a.

As described above, unlike the conventional technique described in the Background Art section, the display device 100a is not provided with a plurality of control units, or is not provided with a communication unit or the like that is used to connect a plurality of storage units. Therefore, it becomes possible to achieve the display device 100a that allows for the lower manufacturing cost and the smaller size of the hardware.

When the antenna unit 110 does not receive the electromagnetic wave, the display data stored in the display data storage unit 143 is output to the display unit 160 using the power supplied from the display power source unit 180. At this time, the main control unit 130a does not operate. The main control unit 130a is constituted of a CPU and the like, for example, and therefore consumes much power. Thus, with the configuration in which the display data is output to the display unit 160 without operating the main control unit 130a, the power consumption can be reduced.

The reduced power consumption allows for the size reduction of the display power source unit 180. Also, it becomes possible to use the display device for a long period of time even when a solar battery or the like with small output power is employed as the display power source unit 180.

Example of Process Flow in Display Device

Next, an example of a process flow in the display device 100a will be described with reference to FIG. 2. FIG. 2 is a flowchart showing an example of a process flow in the display device 100a.

When the antenna unit 110 receives the electromagnetic waves (YES in Step (hereinafter referred to as “S”) 11), the power generation unit 170 supplies the wireless communication power generated in the rectifying circuit to the wireless communication power driver unit 51, and operates the wireless communication power driver unit 51 (S12).

Thereafter, the communication data processing unit 131a acquires the communication data from the electromagnetic waves received by the antenna unit 110, and stores the acquired communication data in the communication data storage unit 141 (S13). Also, the communication data stored in the communication data storage unit 141 may be read out, and the read-out communication data may be sent to the reader/writer device 200 through the communication control unit 120 and the antenna unit 110.

Next, the display data processing unit 132a generates the image data in which contents of the communication data stored in the communication data storage unit 141 are shown in a prescribed area, thereby generating the display data, and the generated display data is stored in the display data storage unit 143 (S14). Here, if template image data is stored in the template image storage unit 142, the display data processing unit 132a generates image data that represents the contents of the communication data, which was read out from the communication data storage unit 141, and generates the display data by combining the generated image data and the template image data read out from the template image storage unit 142.

If the display data stored in the display data storage unit 143 is updated (YES in S15), the display control unit 150 reads out the display data stored in the display data storage unit 143, and the display data is sequentially output to the display unit 160 as signals for the respective pixels that constitute the display unit 160 for a prescribed period of time, thereby displaying the display data on the display unit 160 (S16). When a plurality of pieces of display data are stored in the display data storage unit 143, the plurality of pieces of display data may be sequentially output to the display unit 160.

When the antenna unit 110 is receiving the electromagnetic waves in Step S16, the display control unit 150 is driven by the wireless communication power supplied from the power generation unit 170. On the other hand, when the antenna unit 110 is not receiving the electromagnetic wave in Step S16, the display control unit 150 is driven by the power supplied from the display power source unit 180.

On the other hand, when the antenna unit 110 is not receiving the electromagnetic waves in Step S11 (NO in S11), and when the instruction input unit 190 receives an instruction to output the display data stored in the display data storage unit 143 to the display unit 160 (YES in S17), the display control unit 150 reads out the display data stored in the display data storage unit 143, and sequentially outputs the read-out display data as signals for the respective pixels that constitute the display unit 160 to the display unit 160 for a prescribed period of time (S18).

Here, when a plurality of pieces of display data are stored in the display data storage unit 143, the plurality of pieces of display data may be sequentially output to the display unit 160, or, an instruction to select display data that is to be output to the display unit 160 may be received by the instruction input unit 190 and only the selected display data may be output to the display unit 160.

If the instruction input unit 190 does not receive the instruction to output the display data stored in the display data storage unit 143 to the display unit 160 (NO in S17), but receives the instruction to delete the display data stored in the display data storage unit 143 (YES in S19), the display control unit 150 deletes the display data stored in the display data storage unit 143 (S20).

In Steps S17 to S20, the display data storage unit 143, the display control unit 150, the display unit 160, and the instruction input unit 190 are driven by the power supplied from the display power source unit 180.

Modification Example

In the above description, the configuration in which the display data processing unit 132a of the main control unit 130a included in the display device 100a generates the display data was described, but the configuration is not limited to such. The display device 100a may be configured such that the display data is generated by the reader/writer device 200, and the main control unit 130a acquires the display data from the reader/writer device 200, and stores the acquired display data in the display data storage unit 143, for example.

### Embodiment 2

In Embodiment 1, the configuration in which the display device is provided with the communication data storage unit 141 and the display data storage unit 143, and the communication data is stored in the communication data storage unit 141, and the display data is stored in the display data storage unit 143 was described. However, the configuration is not necessarily limited to such. In the present embodiment, a configuration in which the communication data and the display data are stored in a single storage unit will be described.

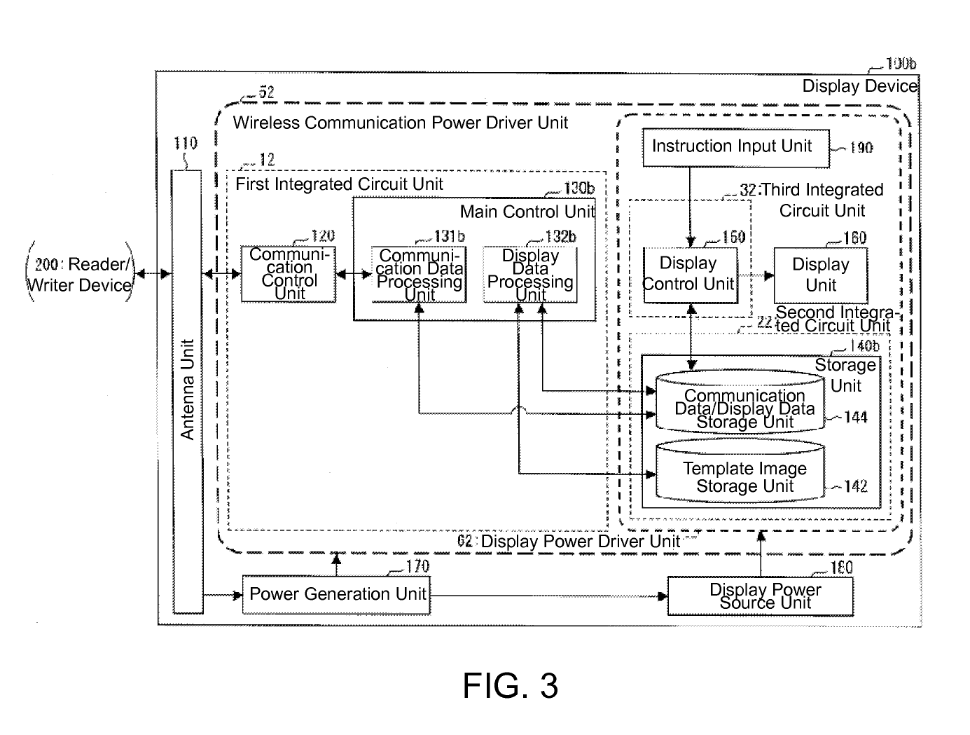

An embodiment of the present invention will be described below with reference to FIG. 3. For ease of explanation, units that have the same functions as those of the respective units shown in Embodiment 1 are given the same reference characters, and their descriptions are omitted.

Configuration of Display Device

A configuration of a display device 100b will be described with reference to FIG. 3. FIG. 3 is a block diagram showing a configuration of a primary portion of the display device 100b. As shown in FIG. 3, the display device 100b is provided with the same units as those of the display device 100a, except that a storage unit 140b is provided instead of the storage unit 140a, and a main control unit 130b is provided instead of the main control unit 130a.

The storage unit 140b stores various kinds of data and the like that are read out by the main control unit 130b, and is constituted of a nonvolatile storage device such as EEPROM.

Specifically, the storage unit 140b includes a communication data/display data storage unit (the communication data storage unit, the display data storage unit, and the storage unit) 144. The communication data/display data storage unit 144 stores, in a readable state, a piece or a plurality of pieces of communication data acquired from the reader/writer device 200 by wireless communication. Also, the communication data/display data storage unit 144 stores, in a readable state, a piece or a plurality of pieces of display data that is to be displayed on the display unit 160.

The storage unit 140b may further include the template image storage unit 142.

The main control unit 130b controls operations of the respective units provided in the display device 100b. The main control unit 130b can be constituted of a CPU, memory, and the like, for example. In this case, the main control unit 130b reads out various programs stored in the storage unit 140b to a first storage unit constituted of RAM or the like, for example, and runs the programs therein. This way, the respective units in the display device 100b are controlled, and respective functions provided in the display device 100b are performed. The main control unit 130b may be constituted of hardware logic such as an ASIC.

Specifically, the main control unit 130b is provided with the communication data processing unit (communication data acquisition unit) 131b and the display data processing unit (display data generation unit) 132b.

The communication data processing unit 131b controls the communication control unit 120, acquires the communication data from the electromagnetic waves received by the antenna unit 110, and stores the acquired communication data in the communication data/display data storage unit 144. The communication data processing unit 131b also reads out the communication data stored in the communication data/display data storage unit 144, and sends the read-out communication data to the reader/writer device 200 through the communication control unit 120 and the antenna unit 110.

When the communication data is stored in the communication data/display data storage unit 144, the display data processing unit 132b generates image data that shows contents of the stored communication data in a prescribed area, thereby generating the display data. Thereafter, the display data processing unit 132b stores the generated display data in the communication data/display data storage unit 144.

If template image data is stored in the template image storage unit 142, the display data processing unit 132b generates image data that represent the contents of the communication data that was read out from the communication data/display data storage unit 144. Then, the display data processing unit 132b generates the display data by combining the generated image data and the template image data that was read out from the template image storage unit 142.

In the present embodiment, the power generation unit 170 supplies the wireless communication power respectively to the communication control unit 120, the main control unit 130b, the storage unit 140b, the display control unit 150, the display unit 160, and to the instruction input unit 190. These units that receive the wireless communication power from the power generation unit 170 in the present embodiment are referred to as a wireless communication power driver unit 52 in FIG. 3.

In the present embodiment, the display power source unit 180 supplies power respectively to the storage unit 140b, the display control unit 150, the display unit 160, and to the instruction input unit 190. These units that receive power from the display power source unit 180 in the present embodiment are referred to as a display power driver unit 62 in FIG. 3.

Example of Configuration of Integrated Circuits

When the respective units in the display device 100b are provided as integrated circuits, the following integrated circuits can be configured, for example: (1) one integrated circuit (first integrated circuit unit 12) constituted of the communication control unit 120 and the main control unit 130b; (2) another integrated circuit (second integrated circuit unit 22) constituted of the communication data/display data storage unit 144; and (3) yet another integrated circuit (third integrated circuit unit 32) constituted of the display control unit 150. In this configuration, the display device 100b is constituted of the first integrated circuit unit 12, the second integrated circuit unit 22, and the third integrated circuit unit 32, in addition to the antenna unit 110. The first integrated circuit unit 12, the second integrated circuit unit 22, and the third integrated circuit unit 32 are driven by the wireless communication power supplied from the power generation unit 170, and the second integrated circuit unit 22 and the third integrated circuit unit 32 are driven by power supplied from the display power source unit 180. The first integrated circuit unit 12 is not driven by the power supplied from the display power source unit 180.

It is preferable that at least the first integrated circuit unit 12 be formed as a different IC chip from an IC chip(s) for the second integrated circuit unit 22 and the third integrated circuit unit 32. Also, if the display unit 160 is made of low temperature polysilicon TFT (Thin Film Transistor) liquid crystal, it is preferable that the display unit 160 and the display control unit 150 be integrally formed. Because the first integrated circuit unit 12 is also included in the conventional IC card, it becomes possible to use a general-purpose IC chip for the IC chip for the first integrated circuit unit 12, and as a result, the manufacturing cost of the display device 100b can be reduced.

Even when the first integrated circuit unit 12, the second integrated circuit unit 22, and the third integrated circuit unit 32 are formed as a single IC chip, the two types of power source described above (the power generation unit 170 and the display power source unit 180) are provided for the IC chip.

Characteristic Operations of Display Device

In the display device 100b having the above-mentioned configuration, when the antenna unit 110 receives the electromagnetic waves, the wireless communication power driver unit is driven by the wireless communication power, and the main control unit 130b stores the communication data and the display data in the communication data/display data storage unit 144. In other words, data storage and readout for the communication data/display data storage unit 144 are performed by the single main control unit 130b.

As described above, unlike the conventional technique described in the Background Art section, the display device 100b is not provided with a plurality of control units, or is not provided with a communication unit or the like that is used to connect a plurality of storage units. Therefore, it becomes possible to achieve the display device 100b that allows for the lower manufacturing cost and the smaller hardware size.

When the antenna unit 110 does not receive the electromagnetic waves, the display data stored in the communication data/display data storage unit 144 is output to the display unit 160 using the power supplied from the display power source unit 180. At this time, the main control unit 130b does not operate. The main control unit 130b is constituted of a CPU and the like, for example, and therefore consumes much power. Thus, with the configuration in which the display data is output to the display unit 160 without operating the main control unit 130b, the power consumption can be reduced.

The reduced power consumption allows for the size reduction of the display power source unit 180. Also, it becomes possible to use the display device for a long period of time even when a solar battery or the like with small output power is employed as the display power source unit 180.

Additional Descriptions

Lastly, the main control unit 130a and the main control unit 130b may be achieved through hardware logic, or may be constituted of a CPU.

When using a CPU, the display device 100 is provided with ROM (read only memory) that stores the programs, RAM (random access memory) in which the programs are loaded, a storage device (recording medium) such as memory that stores the programs and various kinds of data, and the like, in addition to the main control unit 130a or the main control unit 130b as a CPU that runs commands of the control programs and that thereby implements the respective functions. The object of the present invention can also be achieved as follows: storing the program codes (executable programs, intermediate program codes, program source) of the control programs of the display device 100, which are software that implements the functions described above, in the recording medium in a computer readable state; supplying the recording medium to the display device 100; and reading and running the program codes stored in the storage medium through the computer (or a CPU or an MPU).

The following media can be used for the above-mentioned recording medium, for example: tapes such as magnetic tapes and cassette tapes; disks including magnetic disks such as floppy (registered trademark) disks and hard disks or optical disks such as CD-ROMs, MOs, MDs, DVDs, and CD-Rs; cards such as IC cards (including memory cards) and optical cards; semiconductor memory such as mask ROM, EPROM, EEPROM, and flash ROM, or the like.

The display device 100 may be configured so as to be connectable to communication network, and the program codes may be supplied through the communication network. There is no special limitation on such communication network, and Internet, Intranet, Extranet, LAN, ISDN, VAN, CATV communication network, Virtual Private Network, telephone network, mobile communication network, satellite communication network, or the like can be used, for example. Also, there is no special limitation on transmission medium that constitutes the communication network, and wired network such as IEEE 1394, USB, power-line carrier, cable TV circuits, telephone lines, and ADSL lines, or wireless network such as infrared light including IrDA and remote controls, Bluetooth (registered trademark), wireless network defined in IEEE 802.11, HDR, mobile telephone network, satellite circuits, digital terrestrial lines can be used, for example. The present invention can also be achieved by using, as the program codes, computer data signals embedded in carrier waves that are electronically transmitted.

As described above, in the present specification, a “unit” does not necessarily mean a physical unit, but also includes functions of the respective units that are achieved by the software. Moreover, a single function may be achieved by two or more physical units, or two or more functions may be achieved by a single physical unit.

The display device according to the present invention may further includes a communication data storage unit that is supplied with power from the first power supply unit and that stores the communication data acquired by the communication data acquisition unit.

According to this configuration, the communication data acquired by the communication data acquisition unit can be stored in the communication data storage unit.

This results in an effect of allowing the communication data to be used for other purposes than generating the display data.

The display device according to the present invention may also be configured such that the communication data acquisition unit, the communication data storage unit, and the display data generation unit are formed as an IC chip different from an IC chip(s) for the display data storage unit and the display control unit.

According to this configuration, the communication data acquisition unit, the communication data storage unit, and the display data generation unit are formed in a different IC chip from an IC chip in which the display data storage unit and the display control unit are formed.

The IC chip forming the control unit (hereinafter also referred to as a main control unit) that includes the communication data acquisition unit and the display data generation unit and the communication data storage unit has been widely used as a general-purpose IC chip.

Therefore, the general-purpose IC chip can be used as the IC chip for the main control unit that includes the communication data acquisition unit and the display data generation unit and the communication data storage unit, which results in an effect of reducing the manufacturing cost of the device.

In the display device according to the present invention, the communication data storage unit may also be supplied with power by the second power supply unit, and the communication data storage unit and the display data storage unit may be integrally formed as a single storage unit.

According to this configuration, the communication data storage unit and the display data storage unit are integrally formed. That is, the communication data storage unit and the display data storage unit are formed as a single storage unit.

Therefore, because the storage units respectively having different operating voltages can be integrally formed, the power consumption can be reduced. Also, because the hardware configuration of the device can be simplified, an effect of reducing the manufacturing cost of the device can be achieved.

Further, in the display device according to the present invention, the communication data acquisition unit and the display data generation unit, the storage unit, and the display control unit may be respectively formed on different IC chips.

According to this configuration, the storage unit is formed on an IC different chip from an IC chip(s) for the communication data acquisition unit and the display data generation unit and an IC chip for the display control unit.

By integrally forming the storage units on an IC chip different from the IC chip(s) for the communication data acquisition unit and the display data generation unit, it becomes possible to form an IC chip that is suitable for the storage unit. Furthermore, the general-purpose IC chip can be used as the IC chip for the storage unit.

This results in effects of simplifying the hardware configuration of the device and reducing the manufacturing cost of the device.

The display device according to the present invention may further include an image data storage unit that is supplied with power from the first power supply unit and that stores image data as a template of the display data, and the display data generation unit may read out the image data stored in the image data storage unit, and may generate the display data by combining the read-out image data and the image data that represents the contents of the communication data.

According to this configuration, the display data is generated by combining the template image data and the image data that represents the contents of the communication data.

Therefore, even if the communication data is constituted of text data and numerical data, and does not include image data, the display data can be generated by combining the communication data and the template image data. Also, because there is no need to acquire image data having large data volume from the external device, an effect of minimizing the communication time with the external device can be achieved.

In the display device according to the present invention, the second power supply unit may be a rechargeable battery, and may be charged by power supplied from the first power supply unit.

According to this configuration, the second power supply unit is charged every time when the electromagnetic waves are received. Therefore, it becomes possible to extend a battery life during which the second power supply unit can supply power.

In the display device according to the present invention, the display unit may be made of lower temperature polysilicon TFT (Thin Film Transistor) liquid crystal.

According to this configuration, the display unit with higher luminance, lower power consumption, and a thinner profile can be achieved. Also, a shock resistance thereof can be improved.

In the display device according to the present invention, the display unit and the display control unit may be integrally formed.

According to this configuration, by the integrally forming the two components, the number of components can be reduced, and a shock resistance and a vibration resistance can be improved.

The display device according to the present invention may further include storage elements in respective pixels for maintaining pixel signals that represent images, and the storage elements may maintain the pixel signals that is specified by the display data output from the display control unit.

According to this configuration, because the image is continuously displayed, rewriting to the pixels is unnecessary, and therefore, the power consumption can be reduced.

The display device may be achieved by using a computer. In this case, the control programs of the display device for operating the computer as the respective units above so as to achieve the display device through the computer, and a computer-readable recording medium that has the control programs stored therein are also included in the scope of the present invention.

The present invention is not limited to each of the embodiments described above, and various modifications can be made without departing from the scope of claims. Embodiments obtained by appropriately combining techniques that are respectively disclosed in different embodiments are also included in the technical scope of the present invention.

The specific embodiments and examples described in the detailed description of the invention section serve solely to illustrate the technical details of the present invention. Therefore, the present invention should not be narrowly interpreted within the limits of such embodiments and examples, but rather may be implemented in many variations without departing from the spirit of the present invention and the scope of claims described below.

### INDUSTRIAL APPLICABILITY

The present invention can be applied to a display device that is supplied with power from an external device and that displays data acquired from the external device. The present invention can be suitably applied to an IC card provided with a display unit in particular.

### DESCRIPTION OF REFERENCE CHARACTERS

100 display device

100a display device

100b display device

110 antenna unit

131a communication data processing unit (communication data acquisition unit)

131b communication data processing unit (communication data acquisition unit)

132a display data processing unit (display data generation unit)

132b display data processing unit (display data generation unit)

141 communication data storage unit

142 template image storage unit (image data storage unit)

143 display data storage unit

144 communication data/display data storage unit (communication data storage unit, display data storage unit, storage unit)

150 display control unit

160 display unit

170 power generation unit (first power supply unit)

180 display power source unit (second power supply unit)

190 instruction input unit

200 reader/writer device (external device)

1. A display device, comprising:
a display unit;
an antenna unit that receives electromagnetic wave from an external device;
a communication data acquisition unit that acquires communication data carried by the electromagnetic wave;
a display data generation unit that generates display data to be displayed on the display unit from the acquired communication data and that stores said generated display data in a display data storage unit;
a display control unit that outputs the display data stored in the display data storage unit to the display unit;
a first power supply unit that is activated when the antenna unit is receiving the electromagnetic wave and that supplies power acquired from said received electromagnetic wave to at least the communication data acquisition unit, the display data generation unit, the display unit, the display control unit, and to the display data storage unit; and
a second power supply unit that is activated when the antenna unit is not receiving the electromagnetic wave and that supplies power to the display unit, the display control unit, and to the display data storage unit.

2. The display device according to claim 1, further comprising a communication data storage unit that is supplied with power from the first power supply unit and that stores the communication data acquired by the communication data acquisition unit.

3. The display device according to claim 2, wherein the communication data acquisition unit, the communication data storage unit, and the display data generation unit are formed as an IC chip different from an IC chip for the display data storage unit and the display control unit.

4. The display device according to claim 2, wherein the communication data storage unit is further supplied with power by the second power supply unit, and
wherein the communication data storage unit and the display data storage unit are integrally formed as a single storage unit.

5. The display device according to claim 4, wherein the communication data acquisition unit and the display data generation unit, the storage unit, and the display control unit are respectively formed on different IC chips.

6. The display device according to claim 1, further comprising a template image data storage unit that is supplied with power from the first power supply unit and that stores template image data as a template of the display data,
wherein the display data generation unit reads out the template image data stored in the template image data storage unit, and generates the display data by combining said read-out template image data and the image data that represents contents of the communication data.

7. The display device according to claim 1, wherein the second power supply unit is a rechargeable battery, and is charged by power supplied from the first power supply unit.

8. The display device according to claim 1, wherein the display unit is made of lower temperature polysilicon TFT (Thin Film Transistor) liquid crystal.

9. The display device according to claim 8, wherein the display unit and the display control unit are integrally formed.

10. The display device according to claim 1, further comprising a storage element in each pixel in the display unit for maintaining a pixel signal that represents an image,
wherein the storage element maintains the pixel signal specified by the display data output from the display control unit.
